(19) United States
(12) Patent Application Publication
(10) Pub. No.: US 2018/0326794 A1
(43) Pub. Date: Nov. 15, 2018

(54) TWISTED SIPES

(71) Applicants: Mark COLLETT, Simpsonville, SC (US); Francois HOTTEBART, Royat (FR); Xavier NEAU, Greenville, SC (US); Timothy WHITE, Greer, SC (US)

(72) Inventors: Mark COLLETT, Simpsonville, SC (US); Francois HOTTEBART, Royat (FR); Xavier NEAU, Greenville, SC (US); Timothy WHITE, Greer, SC (US)

(73) Assignee: COMPAGNIE GENERALE DES ETABLISSEMENTS MICHELIN, Clermont-Ferrand (FR)

(21) Appl. No.: 15/771,850

(22) PCT Filed: Oct. 28, 2016
(86) PCT No.: PCT/US2016/059471

§ 371 Date: Apr. 27, 2018

(30) Foreign Application Priority Data
Oct. 30, 2015 (US) PCT/US2015/058439

(51) Int. Cl. B60C 11/12; B60C 11/03

(52) U.S. Cl. CPC B60C 11/1222; B60C 11/1281; B60C 11/0323; B60C 11/1218

(57) ABSTRACT

The invention includes tire treads, tires including the tire treads, and methods of forming a tire tread. The tire tread includes a length extending in a lengthwise direction, a width extending in a lateral direction, and a thickness extending in a depth-wise direction from an outer, ground-engaging side of the tread. The tire treads further include a sipe having a length, a height, a width, a thickness extending in a direction of the sipe width, and a cross-section taken along a plane extending in a direction of the sipe width and height, where the cross-section twists as the sipe thickness extends along the length of the sipe. Method of forming the tire tread includes molding into the tread a sipe and a void feature as recited herein.

### CROSS-REFERENCE TO RELATED APPLICATIONS

This application claims priority to, and the benefit of, International Patent Application No. PCT/US2015/058439 filed on Oct. 30, 2015 with the U.S. Patent Office (as the US Receiving Office), which is hereby incorporated by reference.

### BACKGROUND OF THE INVENTION

### Field of the Invention

This invention relates generally to tire treads, and more particularly, to tire treads having sipes, where at least a portion of the sipe is twisted so as to create varying angles of inclination throughout the tire tread block.

### Description of the Related Art

Tire treads are known to include a pattern of voids and/or discontinuities such arranged along a ground-engaging side of the tread to provide sufficient traction and handling during particular conditions. For example, grooves provide voids into which water, mud, or other environmental materials may be diverted to better allow the tread surface to engage a ground surface. By providing the pattern of voids/discontinuities, tread elements are formed along the tread, where the outer portion of said elements are arranged along the outer side of the tread to provide traction as the outer side engages the ground surface (that is, a surface upon with the tire operates, which is also referred to herein as a tire operating surface).

It is well known that the tire tread wears during tire operation due to the generation of slip between the outer side of the tread and the tire operating surface. This not only occurs when the rolling direction of the tire is biased relative to the direction of vehicle travel to generate lateral traction forces, such as when a vehicle is changing direction during turning or cornering maneuvers, but also when the vehicle is traveling in a straight line.

In certain instances, it is advantageous to employ sipes, which are narrow voids or slits that generally close at some instance within a tire's footprint, which is the area of contact between the tire and the tire operating surface. For example, sipes can offer benefits in traction, such as in snow. Sipes, however, can reduce the stiffness of a tire tread, resulting in undesired tread wear. Therefore, there is a need to reduce the occurrence of wear when employing the use of sipes in tire treads, in particular by providing sipes which facilitate increased interlocking between tire tread blocks.

### SUMMARY OF THE INVENTION

The present invention includes tire treads, tires including the tire treads, and methods of forming a tire tread. In particular embodiments, an inventive tire tread comprises: a length extending in a lengthwise direction, the lengthwise direction being a circumferential direction when the tread is arranged on a tire; a width extending in a lateral direction, the lateral direction being perpendicular to the lengthwise direction; and, a thickness extending in a depthwise direction from an outer, ground-engaging side of the tread, the depthwise direction being perpendicular to both the lengthwise direction and the widthwise direction of the tread. The inventive treads further include a sipe having a length, a height, a width, a thickness extending in a direction of the sipe width, and a cross-section taken along a plane extending in a direction of the sipe width and height, where the cross-section twists as the sipe thickness extends along the length of the sipe.

Particular embodiments of the inventive method of forming the tire tread comprises molding into the tread a sipe as recited herein.

The foregoing and other embodiments, objects, features, and advantages of the invention will be apparent from the following more detailed descriptions of particular embodiments of the invention, as illustrated in the accompanying drawings wherein like reference numbers represent like parts of the invention.

### DETAILED DESCRIPTION OF THE DRAWINGS

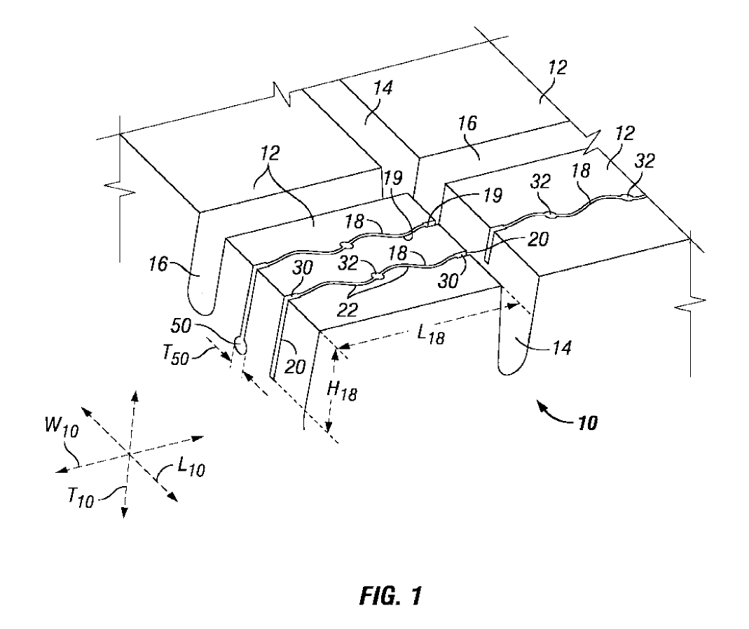

FIG. 1 is a partial perspective view of a tire tread showing a plurality of tread blocks separated by lateral and longitudinal grooves, where the tread blocks include one or more sipes, in accordance with an embodiment of the invention.

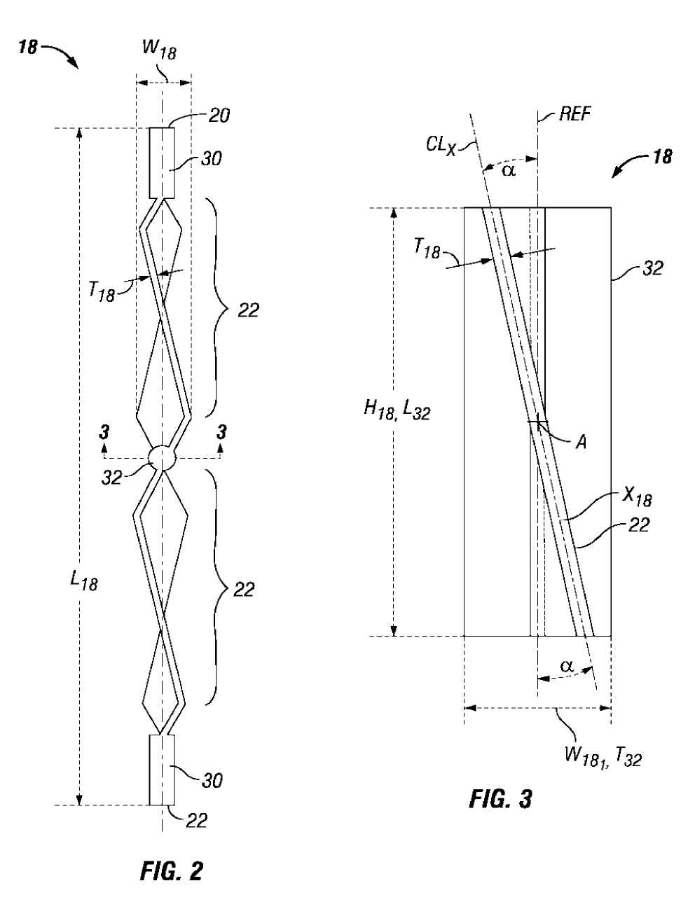

FIG. 2 is a top view of a sipe, in accordance with an embodiment of the invention.

FIG. 3 is a sectional view of the sipe shown in FIG. 2 taken along line 3-3.

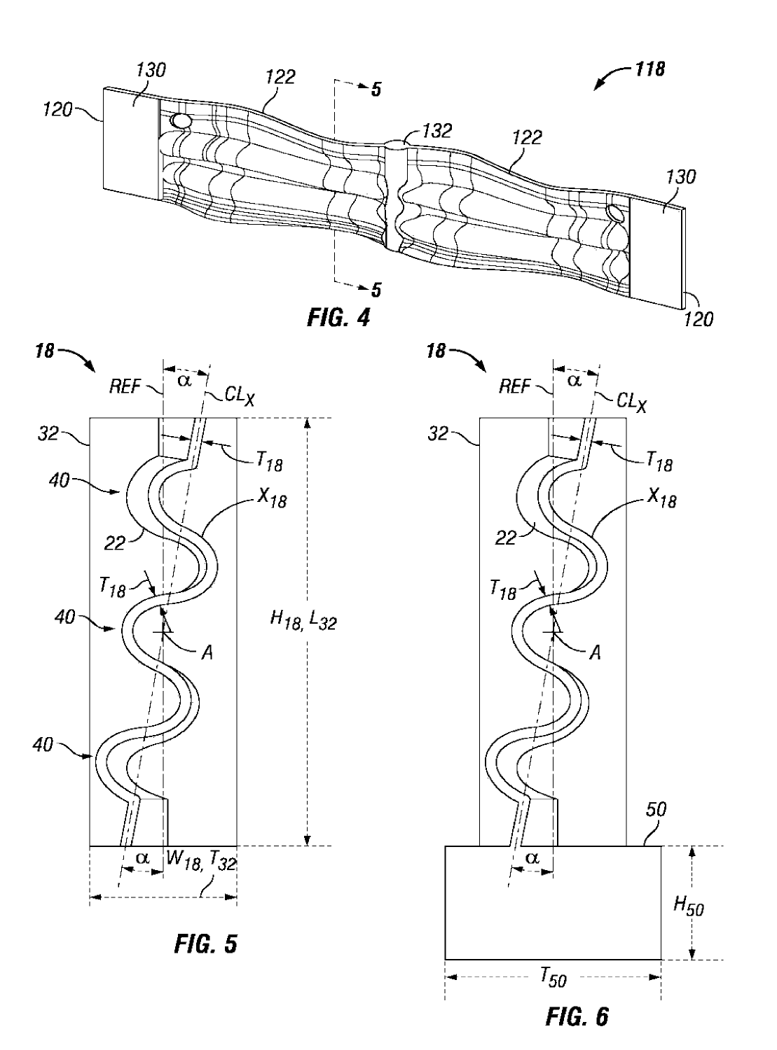

FIG. 4 is a perspective view of a sipe-molding member, in accordance with an embodiment of the invention.

FIG. 5 is a sectional view of a sipe formed by the sipe-molding member of FIG. 4, taken along line 5-5.

FIG. 6 is section view of the sipe of FIG. 5 in an alternative embodiment having a submerged void, in accordance with another embodiment of the invention.

### DETAILED DESCRIPTION OF PARTICULAR EMBODIMENTS

The present invention includes methods for forming a tire tread, tire treads, and tires including said treads, where any such tread includes one or more sipes having a length, a height, a width, a thickness extending in a direction of the sipe width, and a cross-section taken along a plane extending in a direction of the sipe width and height, where the cross-section twists as the sipe thickness extends along the length of the sipe. In providing one or more sipes, it is understood that one sipe or a plurality of sipes may be provided in any tread. By virtue of employing such treads, an increased rigidity in the contact patch is a result of an increase in interlocking between tire tread blocks, which when coupled with a lower rigidity at the exit of the contact patch, results in reduced tread wear while also continuing to obtain tire/vehicle performance benefits commonly achieved utilizing one or more of such sipes.

With regard to the tire treads described herein, having already the noted one or more sipes, it is appreciated that each such tread includes a length, width, and thickness. The length extends in a lengthwise direction. As the tread may be formed with the tire, or separately for later installation on the tire, such as during retreading operations, for example, the lengthwise direction of the tread is a circumferential (that is, annular) direction when the tread is arranged on a tire. The width extends in a lateral direction, the lateral direction being perpendicular to the lengthwise direction, while the thickness extends in a depthwise direction from an outer, ground-engaging side of the tread, the depthwise direction being perpendicular to both the lengthwise direction and the widthwise direction of the tread. By way of example, an exemplary tire tread is partially shown in FIG. 1, where tire tread 10 includes a plurality of tread blocks 12 separated by longitudinal grooves 14 and lateral grooves 16. The tire tread extends in directions of the tread length L₁₀, tread width W₁₀, and tread thickness T₁₀. Each tread block 12 includes one or more sipes 18 each having a length L₁₈ extending at least partially in a direction of the tread width W₁₀, a height H₁₈ extending at least partially in a direction of the tread depth T₁₀ and perpendicular to the tread length L₁₀, and a thickness T₁₈. As best seen in FIG. 1, each sipe 18 is arranged between opposing sides or surfaces 19 of the tread within the tread thickness T₁₀.

With specific regard to the sipes, as noted above, particular embodiments of such tire treads include a sipe having a length, a height, a width, and a thickness, each of which extend in a direction perpendicular to the other. The sipe thickness extends in a direction of the sipe width. A cross-section of the sipe, taken along a plane extending in a direction of the sipe width and height, twists as the sipe thickness extends along the length of the sipe. In twisting as the sipe thickness extends along the length of the sipe, the sipe cross-section rotates about a twisting axis, in a direction of the sipe width as the sipe thickness extends along the length of the sipe. The twisting of the cross-section along the length of the sipe may also be described as the sipe cross-section having a centerline, the centerline extending at least partially in the direction of the sipe height and along the cross-section to define a neutral axis (a neutral bending axis) for the cross-section or to separate the cross-section into two equal areas, such that the sipe cross-section and its centerline rotate about a rotational axis (twisting axis) back and forth by a range of angles measured relative to a reference line extending in the direction of the tread thickness (that is, substantially or fully in the direction of the sipe height, wherein said direction is perpendicular to both the directions of the tread length and width). Stated differently, in taking different cross-sections along the length of the sipe, the different cross-sections each having a centerline as described above, where the different cross-section centerlines are twisted relative to each other by an angle (also referred to as an inclination angle). For example, in certain instances, the sipe twists back and forth one or more times, by a range of angles from zero degrees (0°) to at least eighteen degrees (18°). By virtue of providing a sipe having such features, increased interlocking of tire tread block is achieved, resulting in improved tire wear. It is appreciated that in other examples, the range of angles extends from zero degrees up to 20 to 30 degrees (20° to 30°), although greater angles are contemplated. It is appreciated that the cross-section is associated with a sipe-forming portion of the sipe-forming member. In particular embodiments, for example, the cross-section is associated with an intermediate sipe portion (discussed further below), which is configured to form a portion of the sipe having a thickness equal to or less than 1.0 mm or less, 0.4 mm or less, or 0.2 mm or less, in certain embodiments.

With reference to FIGS. 2 and 3, one embodiment of a sipe 18 is shown in top and sectional views, respectively. In particular, sipe 18 is shown to have a thickness T₁₈ extending in the direction of the length L₁₈ and height H₁₈ of the sipe. With specific reference to FIG. 3, sipe 18 has a cross-section X₁₈ taken along a plane extending in a direction of the sipe width and height, this plane being represented by section line 3-3 in FIG. 2. This cross-section forms a portion of a sipe thickness (less than 1.0 mm, 0.4 mm, or 0 2 mm, for example), and is more specifically taken in the intermediate sipe portion 22. As can be seen in both figures, sipe thickness T₁₈ and cross-section X₁₈ together twist back and forth as each extends along sipe length L₁₈, the twist occurring across any desired of a range of angles (a) measured from a centerline CL_{X} of the cross-section and to a reference line REF extending in the direction of the sipe height H₁₈ (that is, substantially or fully in the direction of the sipe height). The twisting of sipe 18 occurs as the cross-section X₁₈ rotates back and forth about the rotational axis A, creating varying angles of sipe inclination (a) between the reference line REF and the centerline CL_{X} as sipe 18 twists along sipe length L₁₈. In each of the embodiments shown, the cross-section is configured to form a portion of the sipe having a thickness equal to or less than 1.0 mm or less, 0.4 mm or less, or 0.2 mm or less, in an intermediate sipe portion (discussed further below)

In particular embodiments, the sipe may have variable thickness across one or more of its length and height, such features permitting the manufacture and use of sipes with thinner thicknesses and sipe-molding elements with improved strength and stiffness for improved durability. In one embodiment, the sipe has a length defined by two distal ends, where at least one of the distal ends includes an upright void feature having a length extending primarily in the direction of the sipe height, where the sipe thickness between the distal ends includes an intermediate sipe portion, the upright void feature having a thickness greater than the intermediate sipe portion. In extending primarily in a direction of the sipe height, when separating the average direction of extension into vectors extending in the direction of the sipe length, depth, and width, the vector extending in the direction of the sipe height is greatest among the different vectors. It is appreciated that any upright void feature may have any thickness, such as being at least 0.4 mm thick or at least 1.0 mm thick. In certain embodiments, for example, the at least one upright void feature is at least 0.4 mm thick and the intermediate sipe portion is less than 0.4 mm In other exemplary embodiments, the sipe has an upright void feature that is at least 0.4 mm thick and an intermediate sipe portion which is 0.2 mm thick or less. In certain variations, an upright void feature is at least 1.2 mm thick. It is appreciated that a sipe may have one or more upright void features of identical length and thickness, and may comprise various combinations of different shapes, thicknesses and/or lengths, which may be continuous or discontinuous and extend along any linear or non-linear path. A non-linear path may comprise an arcuate path or an undulating path which may be curvilinear or formed of a plurality of linear segments, such as a zig-zag path. In certain embodiments, one or more upright void features are arranged between the distal ends and along the intermediate sipe portion, which are referred to as intermediate upright void features, each of the one or more intermediate upright void features having a thickness greater than the intermediate sipe portion, such as any thickness contemplated above with reference to the upright void features arranged at the distal ends.

For example, with reference to FIGS. 1 and 2, sipes 18 have a length L₁₈ defined by distal ends 20 and an intermediate sipe portion 22. In the embodiment shown, each of the distal ends 20 including an upright void feature 30 with a length extending primarily in the direction of the sipe height H₁₈. Each upright void feature 30 has a thickness T₃₂ that is greater than a thickness T₁₈ of the sipe, and more particularly, of the intermediate sipe portion 22. It is appreciated that any upright void feature may have a variable thickness, where, in certain instances, at least a portion thereof may be as thick as the intermediate sipe portion at a certain location along the length of the upright void feature, even though the upright void feature has a thickness greater than the thickness of the intermediate sipe portion at another location along the upright void feature length. The sipe 18 shown in FIGS. 1 and 2 also includes an intermediate upright void feature 32 arranged along intermediate sipe portion 22, the intermediate upright void feature having a thickness T₃₂ greater than the thickness T₁₈ of the sipe, and more specifically, of the intermediate sipe portion 22. Sipe 18 may have more than one intermediate upright void features 32, as shown by example in FIG. 1, where certain sipes include two (2) intermediate upright void features. Upright void features 30, 32, whether utilized in combination or standing alone, provide additional strength and stiffness to a corresponding sipe-molding member, and in turn permit the manufacture and use of sipes with thinner thicknesses in along the intermediate sipe portion.

It is appreciated that the cross-section of the sipe, such as in the intermediate sipe portion, may form any shape. For example, the cross-section may be symmetrical or asymmetrical relative the centerline. By further example, the cross-section may have constant or variable thickness. In yet further example, the thickness of the cross-section may extend along any linear or non-linear path. A non-linear path may comprise an arcuate path or an undulating path which may be curvilinear or formed of a plurality of linear segments, such as a zig-zag path. For example, in particular embodiments, the sipe-molding member is configured to form one or more undulations within the sipe, whereby the thickness of the sipe, and therefore the thickness of the sipe-molding member, undulates back and forth in a direction of the sipe width or thickness as the sipe extends in a direction of the sipe height and/or length in forming one or more undulations. This undulating connotes the location of the sipe thickness along an undulating, non-linear path, where the path undulates back and forth in a direction of the sipe width or thickness as the path extends in a direction of the sipe height and/or length. Undulating does not connote a variable thickness of the sipe or sipe-molding portion in the sipe molding member, although the thickness of the sipe may vary with or without the sipe thickness undulating. Therefore, it is clear that said undulations form a portion of the cross-section, and also twist as the sipe thickness extends along the length of the sipe. In certain embodiments, the thickness undulating back and forth is interrupted by an intermediate upright void feature as more fully discussed above. In some embodiments, the undulations are situated entirely within the intermediate sipe portion, while in other versions the undulations extend partially into, or entirely through, the length of the upright void features. In certain embodiments, any sipe includes a submerged groove arranged along a bottom of the sipe, the submerged groove having a length extending in the direction of the sipe length.

By way of example, with reference to the exemplary embodiment of FIG. 5, cross-section X₁₈ is shown to have a thickness T₁₈ that undulates back and forth in a direction of the sipe thickness T₁₈ and width W₁₈ as sipe 18 extends in a direction of the sipe height H₁₈ to form a plurality of undulations 40. The thickness can be described as extending along an undulating path. It is appreciated that this sipe may extend additionally along another undulating path in the direction of the sipe length. This undulating thickness occurs while the cross-section X₁₈ and its centerline CL_{X} also twists back and forth about axis A.

The submerged groove is a groove spaced apart or offset from the ground-engaging surface of a new tread in a direction of the tread thickness, which may be later exposed when a sufficient amount of tread thickness has been worn or removed. The submerged groove may form any shape, and extend lengthwise in any linear or non-linear path. It is also appreciated that the submerged groove may be formed to have any thickness. In certain embodiments, the submerged groove has a thickness greater than the thickness of any upright void feature and intermediate void feature. By way of example, with reference to the exemplary embodiment shown in FIG. 6, the sipe of FIG. 5 has been modified in this embodiment to include a submerged groove 50. A submerged groove 50 is also shown in FIG. 1. In FIG. 6, submerged groove 50 is shown to have a height H₅₀ and a thickness T₅₀, which is shown to extend along a non-linear path in a direction of the sipe length.

It is appreciated that any one or a plurality of the sipes described herein may be molded into a tire tread in a method of forming a tire tread using a like sipe-molding member. In the method, a tire tread has a length, a width, and a thickness as described above. In particular embodiments, the method comprising the step of molding into the tread a sipe and a void feature of any variation described herein. As noted above, a sipe-molding member may take the form of the void to be formed in the tread, such as shown in various exemplary embodiments in the figures. An exemplary sipe-molding element 118 for molding a corresponding sipe of the same shape is shown in FIG. 4, the element having a length defined by distal end-forming features 120 for forming corresponding distal ends of the formed sipe, intermediate sipe portion-forming features 122 for forming corresponding intermediate sipe portions of the formed sipe, upright void-forming features 130 for forming corresponding upright void features 30 of the formed sipe, an intermediate upright void-forming feature 132 for forming corresponding an intermediate upright void feature 32 of the formed sipe. It is appreciated that a sipe-molding element may include other features corresponding to any desired portion of a sipe described herein.

It is appreciated that any tread discussed herein may be arranged along an annular pneumatic tire, or may be formed separately from a tire as a tire component for later installation on a tire carcass, in accordance with any technique or process known to one of ordinary skill in the art. For example, the treads discussed and referenced herein may be molded with a new, original tire, or may be formed as a retread for later installation upon a used tire carcass during retreading operations. Therefore, when referencing the tire tread, a longitudinal direction of the tire tread is synonymous with a circumferential direction of the tire when the tread is installed on a tire. Likewise, a direction of the tread width is synonymous with an axial direction of the tire or a direction of the tire width when the tread is installed on a tire. Finally, a direction of the tread thickness is synonymous with a radial direction of the tire when the tread is installed on a tire. It is understood that the inventive tread may be employed by any known tire, which may comprise a pneumatic or non-pneumatic tire, for example.

It is appreciated that any of the tread features discussed herein may be formed into a tire tread by any desired method, which may comprise any manual or automated process. For example, the treads may be molded, where any or all discontinuities therein may be molded with the tread or later cut into the tread using any manual or automated process. It is also appreciated that any one or both of the pair of opposing discontinuities may be originally formed along, and in fluid communication with, the outer, ground-engaging side of the tread, or may be submerged below the outer, ground-engaging side of the tread, to later form a tread element after a thickness of the tread has been worn or otherwise removed during the life of the tire.

By virtue of employing the inventive tread features described herein, which includes selectively twisting certain sipes, as discussed herein, a reduction in tread wear is achieved. These improvements were realized with on-vehicle testing, where a test driver compared different tires each characterized as having sipes twisted by 18 degrees and 0 degrees, respectively. The tests were conducted on a front-wheel compact car on a wear circuit approximating typical driving conditions. Upon comparing the front tires from each test, the tires having sipes twisted by 18 degrees achieved a 15% wear improvement over the tires having sipes that were not twisted.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The terms “at least one” and “one or more” are used interchangeably. The term “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (i.e., not required) feature of the invention. Ranges that are described as being “between a and b” are inclusive of the values for “a” and “b” unless otherwise specified.

While this invention has been described with reference to particular embodiments thereof, it shall be understood that such description is by way of illustration only and should not be construed as limiting the scope of the claimed invention. Accordingly, the scope and content of the invention are to be defined only by the terms of the following claims. Furthermore, it is understood that the features of any specific embodiment discussed herein may be combined with one or more features of any one or more embodiments otherwise discussed or contemplated herein unless otherwise stated.

1. A tire tread comprising:
a length extending in a lengthwise direction, the lengthwise direction being a circumferential direction when the tread is arranged on a tire;
a width extending in a lateral direction, the lateral direction being perpendicular to the lengthwise direction;
a thickness extending in a depthwise direction from an outer, ground-engaging side of the tread, the depthwise direction being perpendicular to both the lengthwise direction and the widthwise direction of the tread; and
a sipe having a length, a height, a width, a thickness extending in a direction of the sipe width, and a cross-section taken along a plane extending in a direction of the sipe width and height, where the cross-section twists as the sipe thickness extends along the length of the sipe_{z}
wherein the sipe length is defined by two distal ends, where at least one of the distal ends includes an upright void feature having a length extending primarily in the direction of the sipe height, where the sipe thickness between the distal ends includes an intermediate sipe portion, the upright void feature having a thickness greater than the intermediate sipe portion.

2. The tire tread of claim 1, where the cross-section twists at varying angles of inclination relative a reference line extending in the direction of the sipe height.

3. The tire tread of claim 2, where the cross-section twists at angles between zero and 18 degrees from the reference line.

4. The tire tread of claim 2, where the cross-section twists at angles between zero and at least 18 degrees from the reference line.

5. The tire tread of any one of claims 1 to 4, where the thickness of the sipe undulates back and forth in a direction of the sipe width as the sipe extends in the direction of the sipe length and/or height.

6. (canceled)

7. The tire tread of claim 1, wherein the upright void features are at least 0.4 mm thick and the intermediate sipe portion is less than 0.4 mm thick or less.

8. The tire tread of claim 1, where an intermediate upright void feature is arranged along the intermediate sipe portion between the distal ends, the intermediate upright void feature having a thickness greater than the intermediate sipe portion.

9. The tire tread of claim 8, where the intermediate upright void feature has a thickness of at least 0.4 mm.

10. The tire tread of claim 1, where the sipe includes a submerged groove arranged along a bottom of the sipe, the submerged groove having a length extending a non-linear path in the direction of the sipe length.

11. The tire tread of claim 10, where the submerged groove has a thickness greater than the thickness of any upright void feature and intermediate void feature.

12. The tire tread of claim 1, where the one or more upright void features form multiple upright void features having the same length.

13. The tire tread of claim 1, where the thickness of the intermediate sipe portion undulates back and forth in a direction of the sipe width as the sipe extends in the direction of the sipe length and/or height.

14. A method of forming a tire tread, the tread having: a length extending in a lengthwise direction, the lengthwise direction being a circumferential direction when the tread is arranged on a tire; a width extending in a lateral direction, the lateral direction being perpendicular to the lengthwise direction; and, a thickness extending in a depthwise direction from an outer, ground-engaging side of the tread, the depthwise direction being perpendicular to both the lengthwise direction and the widthwise direction of the tread, the method comprising the step of:
molding into the tread a sipe, the sipe having a length, a height, a width, a thickness extending in a direction of the sipe width, and a cross-section taken along a plane extending in a direction of the sipe width and height, where the cross-section twists as the sipe thickness extends along the length of the sipe,
wherein the sipe length is defined by two distal ends, where at least one of the distal ends includes an upright void feature having a length extending primarily in the direction of the sipe height, where the sipe thickness between the distal ends includes an intermediate sipe portion, the upright void feature having a thickness greater than the intermediate sipe portion.

15. The tire tread of claim 1, where the sipe has a variable thickness.

16. The tire tread of claim 1, where the cross-section of the sipe has a centerline and the cross-section of the sipe is asymmetrical relative the centerline.
